(19) United States
(12) Patent Application Publication
(10) Pub. No.: US 2018/0093353 A1
(43) Pub. Date: Apr. 5, 2018

(54) METHOD FOR WELDING OF INSULATED PIPE

(71) Applicant: MRP PARTICIPACOES EIRELI, Serra (BR)

(72) Inventor: Marcos Rogérìo PEGORETTI, Vitoria (BR)

(21) Appl. No.: 15/563,804

(22) PCT Filed: Apr. 9, 2015
(86) PCT No.: PCT/BR2015/050039

§ 371 Date: Oct. 2, 2017

(51) Int. Cl. B23K 26/38; B23K 26/40; B23K 9/028; B23K 9/23; E21B 36/00; F16L 13/04

(52) U.S. Cl. CPC B23K 26/38; B23K 26/40; B23K 9/028; E21B 17/00; E21B 36/003; F16L 13/04; B23K 9/23

(57) ABSTRACT

A welding method, to reduce tension due to pipe stretching, for a downhole double-walled insulated pipe is disclosed. The pipe comprises an inner tube, an outer tube, steel spacer rings and insulated material fitted filling the annular space. Special welding links the ends of inner and outer tubes, forming a flexible metallic joint, achieved through the use of filler metal with specific chemical composition during the welding process. The inner tube is heated and extended before the tube welding is performed. The welded joint is strong enough to keep the inner tube in place when it cools down, creating a tension inwards in the tube. This way, when steam flows through the tubing during the operation, the heat stretches the inner tube until the tension direction is outwards, then the tension now becomes about half of the normal tension applied to the tube welded joint with the usual welding process.

### TECHNICAL FIELD

This invention relates to a method or process of joining two steel concentric pipes exposed to different working temperatures. Moreover, this process consists of steps of preheating, arc welding, and normalizing or welding stress relieving.

### BACKGROUND ART

In some oil fields, there are restrictions imposed to the fluid pumping due to its high viscosity. These restrictions can be dealt with, or diminished, by injecting steam downhole to reduce fluid viscosity and allow for a more effective oil pumping. In this method of steam injection the steam can be applied continuously or cyclically, also known as the huff and puff method. It consists of stages of injection and production which results in pipe thermal stress due to the characteristic variations of the fluid being carried.

### SUMMARY OF INVENTION

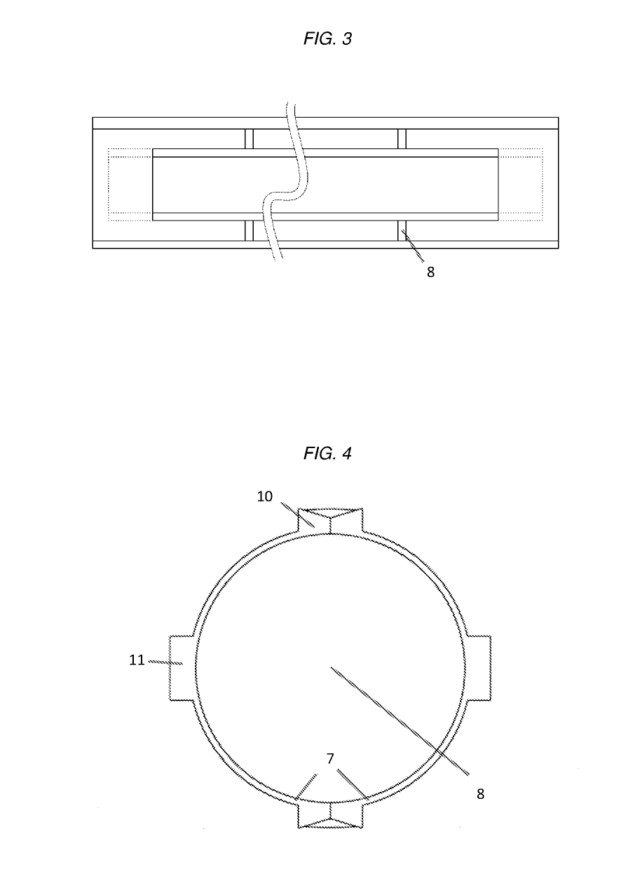

In a preferred embodiment of the invention, the inner (1) and outer (2) pipes of a double-walled insulated pipe are maintained in concentric relation by spacer rings (8) distributed along the annular space (3) and by the weld (6) at both ends. The insulated pipe is designed to contain a fluid that is hotter than the external ambient. The inner pipe (1) consequently elongates relative to the outer pipe (2) causing a stress in both -joint welding (6). A welding method is so sized that the stress will be below its yield point. By preheating the inner tube (1), so that it stretches in a range of 1.5 to 4% of its original length (so the inner pipe shall originally have a length of 95% to 98.5% of the full length of the outer tube (2)), as shown in FIG. 3, while keeping the outer tube (2) at a lower temperature, and then soldering, therefore achieving a condition of less welding stress in work conditions. Welding practices also affect welded joint performance in service. The matching-composition filler metal shall be designed so the joint has a combination of high tensile yield strength and high modulus of elasticity.

### Technical Problem

There are several steam injection tubes with the function of minimizing heat losses carrying steam downhole. However, these tubes have some fragilities. They can be damaged easily, lose vacuum (and therefore, the insulation capability) or have broken welding joints due to lack of thermal fatigue resistance. These conditions cause a shorter time between maintenance shutdowns, to substitute tubes, which results in increased operational costs, as well as increased non-productive time.

In welding certain structures and materials, stresses are set up therein due to localization of the heat from the arc, i.e., there is formation of a thermally affected zone susceptible to have fragile phases. For example, in butt-welding the ends of pipes together, these stresses may become quite pronounced on large heavy walled pipes. Moreover, when such pipes are used to carry steam under high pressure and temperature, it becomes very important that the welds be as nearly perfect as it is possible to make them.

The double-walled pipe's inner tubes react differently than the outer tube, as the outer tubes are not in contact with the hot steam. This causes a difference in temperature that leads to a different extension, which creates shear stress on the welded joints between the inner and outer tubes. In function of the problems cited above, a method was created to reduce said shear stress. This method will be thoroughly discussed in this document.

### Solution to Problem

Through the use of numerical and structural simulations, chemical analysis of weld and also in processes specifically developed for weld qualification (including uniaxial compressive load analysis), we identified that variations of Manganese and Carbon components in the filler metal significantly altered the occurrence of micro-cracks, yield strength and compression /tension strain of the weld joint.

As a result, it was observed that the joint weld efficiency is directly proportional to the percentage of Carbon and inversely proportional to the percentage of Manganese. Based on these conditions, it is proposed the use of filler metal with up to 10% less manganese than the pipe base metal chemical structure and up to 10% more Carbon than what is found in the pipe base metal.

Therefore, due to the metallurgical characteristics of weld material, it should not be affected by failures related to mechanical resistance or brittleness.

### Advantageous Effects of Invention

As the failures are basically due to the combination of the metallurgical changes in the HAZ (heat-affected zone) and the strain field generated by the welding process and the pipe assembly process, welding becomes a very important component in the manufacture of insulated pipe. Thus, in addition to the metallurgical control of the filler metal components, there is also tension control by uniform distribution of such stresses at the pipe ends. It is possible to list at least two major advantages of the present manufacturing method. One is the metallurgical characteristics of the joint, in order to minimize the incidence of fragile phases, decrease the occurrence of micro-cracks and increase the yield strength. The other is heating the inner pipe before the welding is performed, creating a tension inwards in the tube. This way, when steam flows through the tubing during operation, the heat stretches the tube until the tension direction is outwards, then the tension now becomes half of the normal tension applied if the pipe were welded with the usual welding process, i.e., without pre heating.

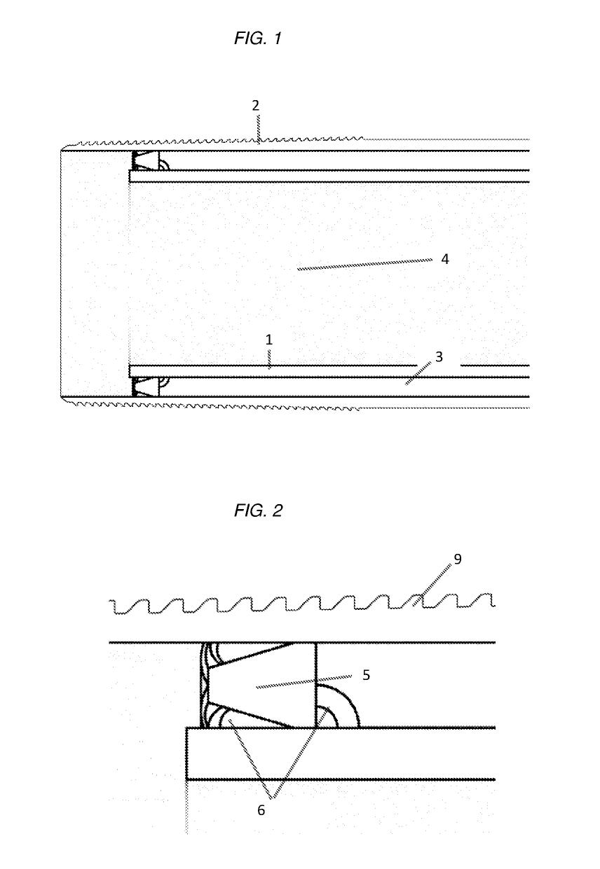

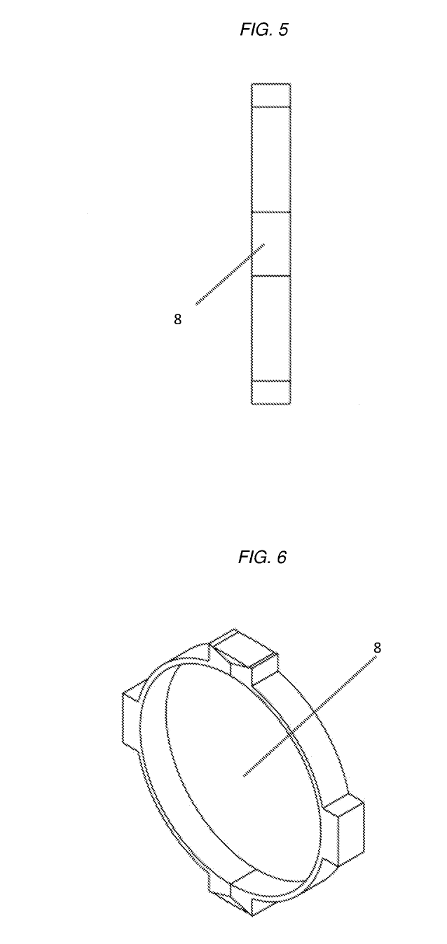

### BRIEF DESCRIPTION OF DRAWINGS

[FIG. 1] is a view of one embodiment of the double-walled well casing of this invention. Specifically in this figure is one of the ends of the pipe.

[FIG. 2] is a closer view at the welded point, showing the welding pattern.

[FIG. 3] is a view that demonstrates the new condition of the pipe under differential thermal expansion.

[FIG. 4] is a frontal view of the spacer ring design.

[FIG. 5] is a side view of the spacer ring design.

[FIG. 6] is an isometric view of the spacer ring design.

### DESCRIPTION OF EMBODIMENTS

Referring to FIG. 1, the image displays the assembly of our double-walled steel pipe (4). The insulated pipe has a steel outer pipe (2) and a steel inner carrier pipe (1). The drawing shows the tube threading (9) on each of the adjoining ends of the outer pipe (1). The outside diameter of the inner pipe (1) shall be at least 1″ smaller than the inner diameter of the steel outer pipe (2), leaving an annular space (3) between the “walls” of the double-walled steel pipe (4). With the exception of the part of the annular space (3) occupied by the spacer ring (8), the annular space (3) generally may be filled with non-metallic insulating materials, such as insulation foam or another insulation materials. The mechanical and thermal proprieties of this insulating material may be manipulated through the use of special manufacturing processes, such as high pressures, ultra-low temperatures or special injection methods, and through the insertion of specific additives, such as coal powder, glass spheres and special fibers.

The spacer ring (8) is a steel laser-cut ring-shaped band having an outer diameter less than the inner diameter of the outer pipe (2), such that a portion of its collar (11) fits within the annular space (3) of each section of the double-walled steel pipe (4). The steel spacer ring (8), by itself, is able to withstand the radial and tangential stress components of a pressurized pipe without bowing or distorting, so it does not have to interface with the outer pipe (2). The spacer ring (8) may be fabricated from carbon steel or any other nonmetallic material capable of withstand the applied loads.

The complete procedure for joining the two pipes may be best understood by referring to FIG. 2. First, the spacer ring (8) is placed along the inner pipe (1) and fixed by welding or with a bolding material such as epoxy. Then, the inner pipe (1) is heated, resulting in and expansion. A steel deflection ring is placed prior to the arc welding. Keeping the deflection ring ensures that the welding will fully fill the annular space.

After the welding step is complete, the pipe goes through a thermal treatment which is done by heating the welded area and then cooling it down in a controlled pace, according to tested curves. The pipe is now ready to be insulated, which is done by drilling holes on both ends of the pipe's outer pipe (2) and using vacuum to fill it with insulation material. These holes are sealed after the operation is complete. With all these steps done, all that is left is threading the tube, according to the necessities specified by the project.

1-16. (canceled)

17. An assembly for joining metal tubes to form a double-walled pipe having an outer tube, an inner tube of smaller diameter than the outer tube, and an annulus between the tubes, the assembly comprising:
a) a first non-threaded steel tube serving as the outer tube;
b) a second non-threaded steel tube serving as the inner tube, dimensioned with a diameter and length so as to fit entirely within the outer tube, and wherein the inner tube is positioned within the outer tube creating an annular space between the tubes;
c) a plurality of metal laser-cut spacer rings located in the annular space, each ring comprising two semi-circular pieces and having an inner diameter equal to an outer diameter of the inner tube and a chamfer (10) on both edges, in a manner to allow the ring and the inner tube to be arc welded together, with rings equidistant spaced 1.5 meters from each other, keeping the inner tube and the outer tube concentric;
d) a welding material for joining ends of the inner tube and the outer tube, using a deflection ring (5) to guide welding; and
e) an insulation material applied within the annular space between the inner tube and the outer tube,
wherein the assembly is completed by mechanical engagement of the inner tube and the spacer rings, welding of the inner tube and the outer tube, and application of the insulation material.

18. The assembly of claim 17 in which the metal laser-cut spacer rings are of a nonmetallic material.

19. The assembly of claim 17 in which the length of the inner tube is within a range of 95% to 98.5% of the full length of the outer tube.

20. The assembly of claim 17 wherein the outer tube is selected from the group consisting of: seamless pipes and welded pipes.

21. The assembly of claim 17 in which one of the tubes is of a nonmetallic material.

22. The assembly of claim 17 in which the metal laser-cut spacer ring pieces are held together with an epoxy bonding material.

23. The assembly of claim 17 in which the mechanical and thermal properties of the insulation material are manipulated by a special manufacturing process selected from the group consisting of: vacuum, and injection of additive.

24. The assembly of claim 23, wherein the injected additive comprises black coal particles.

25. A method for joining metal tubes to form a double-walled pipe having an outer tube, an inner tube of smaller diameter than the outer tube, and an annulus between the tubes, the method comprising:
(a) fabricating a plurality of metal laser cut spacer rings, each ring comprising two semi-circular pieces, having an inner diameter equal to an outside diameter of the inner tube and a chamfer (10) on both edges, wherein the chamfer serves to arc weld the pieces together;
(b) positioning the spacer rings encircling the inner tube with the rings equidistant and located 1.5 meters apart, keeping the inner tube and the outer tube concentric, and subsequently arc welding the spacer rings and the inner tube together;
(c) positioning the outer tube about the inner tube, in a manner to locate the inner tube is lengthwise centrally located within the outer tube, and ensuring that the spacer rings keep the tubes concentric;
(d) heating the inner tube until the inner tube expands about 2% in size;
(e) arc welding the inner tube to the outer tube using a deflection ring (5) to guide the welding and link the tubes;
(f) heating and cooling a welded area at a controlled pace;
(g) drilling two holes into the outer tube for application of an insulation material;
(h) vacuuming the insulation material through the holes, filling the entirety of the annular space;
(i) sealing the holes on the outer tube; and
(j) threading the outer tube.

26. The method of claim 25 wherein the inner tube is heated until expansion lengthwise within a range of 1.5% to 4% of the full tube length occurs.

27. The method of claim 25 wherein the metal laser-cut spacer rings are of a nonmetallic material.

28. The method of claim 25 wherein the metal laser-cut spacer rings are held together with an epoxy bonding material.

29. The method of claim 25 wherein the outer tube is selected from the group consisting of: seamless pipes or welded pipes.

30. The method of claim 25 wherein at least one of the tubes is of a nonmetallic material.

31. The method of claim 25 wherein the joining of the tubes occurs via a flexible joint, using a filler metal comprising up to 10% less manganese than the tube having less manganese, and wherein the filler metal also contains up to 10% more carbon than the tube having the highest carbon percentage, creating a joint with a higher tensile yield strength
